(19) United States
(12) Patent Application Publication
(10) Pub. No.: US 2008/0291209 A1
(43) Pub. Date: Nov. 27, 2008

(54) Encoding Multi-media Signals

(75) Inventors: Akash Damodar Sureka, Pune (IN); Amit Bansal, Pune (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 11/753,588

(22) Filed: May 25, 2007

(51) Int. Cl. G09G 5/39

(52) U.S. Cl. 345/531

(57) ABSTRACT

An aspect of the present invention mitigates bottlenecks in components such as buses in the path of a system memory and a GPU memory. In an embodiment, a graphics processing unit (GPU) receives digital values representing a multi-media signal from an external source, encodes the digital values, and stores the encoded values in a RAM. The RAM may also store instructions which are executed by a CPU. As the digital values are received by the GPU without being stored in the RAM, bottlenecks may be mitigated.

### BACKGROUND

1. Field of Disclosure

The present disclosure relates generally to digital processing of multi-media signals (e.g., voice and video) and more specifically to encoding of such multi-media signals.

2. Related Art

Multi-media signals generally refer to signals representing various forms of information content (e.g., audio, video, text, graphics, animation, etc.). A single signal can represent one or more forms of information, depending on the technology and conventions as is well known in the relevant arts.

Multi-media signals are often encoded using various techniques. In a typical scenario, a multi-media signal is first represented as a sequence of digital values. Encoding then entails generating new digital values (from the sequence of digital values) representing the signal in a compressed format.

Such encoding (or representation in compressed format) can lead to benefits such as reduced storage requirements, enhanced transmission throughput, etc. Various encoding techniques are well known in the relevant arts. Examples of encoding techniques include WMV, MPEG-1, MPEG-2, MPEG-4, H.263 and H.264 for encoding video signals, and WMA, MP3, AEC, AEC+, AMR-NB, and AMR-WB for encoding audio signals.

It is often desirable that the encoding be implemented meeting various requirements as suited in the specific situation.

### BRIEF DESCRIPTION OF THE DRAWINGS

Example embodiments will be described with reference to the following accompanying drawings, which are described briefly below.

FIG. 1 is a block diagram of a multi-media device illustrating an example embodiment in which several aspects of the present invention may be implemented.

FIG. 2 is a block diagram illustrating the processing of multi-media signals in a prior embodiment.

FIG. 3 is a flowchart illustrating the manner in which multi-media signals are encoded in an embodiment of the present invention.

FIG. 4A is a block diagram illustrating the details of an example operating environment in which several aspects of the present invention can be implemented.

FIG. 4B is a block diagram illustrating an example approach to encoding of multi-media signals in one embodiment of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An aspect of the present invention mitigates bottlenecks in components such as buses in the path of a system memory and a GPU memory. In an embodiment, a graphics processing unit (GPU) receives digital values representing a multi-media signal from an external source, encodes the digital values, and stores the encoded values in a RAM. The RAM may also store instructions which are executed by a CPU. As the digital values are received by the GPU without being stored in the RAM, bottlenecks may be mitigated.

In an embodiment, the GPU stores the digital values in a GPU memory prior to performing the encoding operation. The digital values may represent raw data (digital samples generated without further processing) received from the source generating the multi-media signal. The GPU may notify the CPU upon completion of storing encoded data corresponding to each of a successive portions of the multi-media signal.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

### 2. Example Environment

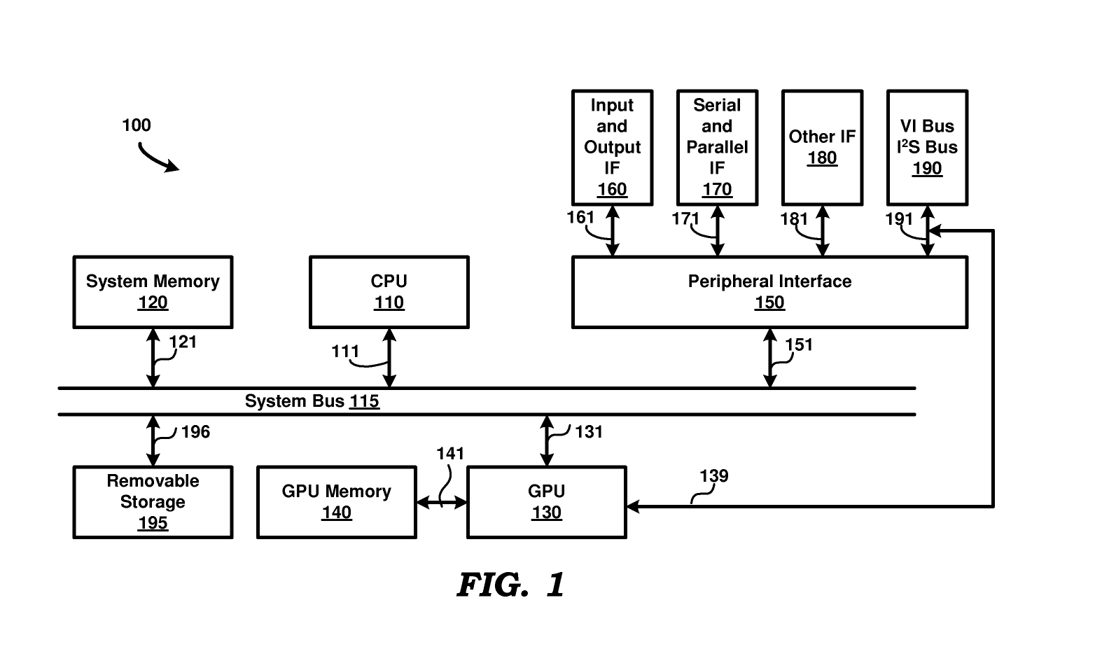

FIG. 1 is a block diagram illustrating an example environment in which several features of the present invention may be implemented. The example environment is shown containing only representative systems for illustration. However, real-world environments may contain more/fewer/different systems/components as will be apparent to one skilled in the relevant arts. Implementations in such environments are also contemplated to be within the scope and spirit of various aspects of the present invention.

Device 100 is shown containing CPU 110, system memory 120, Graphics Processor Unit (GPU) 130, GPU memory 140, peripheral interfaces 150, and removable storage 195. Only the components as pertinent to an understanding of the operation of the example embodiment are included and described, for conciseness and ease of understanding. However embodiments covered by several aspects of the present invention can contain fewer or more components. Each component of FIG. 1 is described in detail below.

CPU 110 represents a central processor(s) which at least in substantial respects controls the operation (or non-operation) of the various other blocks (in device 100) by executing instructions stored in system memory 120. Some of the instructions executed by CPU 110 also represent various user applications (e.g., playing songs/video, video recording, etc.) provided by device 100.

System memory 120 contains various randomly accessible locations which store instructions and/or data used by CPU 110. As noted above, some of the instructions may represent user applications. Other instructions may represent operating system (containing or interfacing with device drivers), etc. System memory 120 may be implemented using one or more of SRAM, SDRAM, DDR RAM, etc. Specifically, pixel values that are to be processed and/or to be used later, may be stored in system memory 120 via path 121 by CPU 110.

Removable storage 195 may store data (e.g. captured video or audio or still images etc.) via path 196. In one embodiment, removable storage 195 is implemented as a flash memory. Alternatively, removable storage 195 may be implemented as a removable plug-in card, thus allowing a user to move the stored data to another system for viewing or processing or to use other instances of plug-in cards.

Removable storage 195 may contain an additional memory unit (e.g. ROM, EEPROM, etc.), which store various instructions, which when executed by CPU 110 and GPU 130 provide various features of the invention described herein. In general, such a memory unit (including RAMs, non-volatile memory, removable or not) from which instructions can be retrieved and executed (by CPU or GPU) are referred to as a computer readable medium. It should be appreciated that the computer readable medium can be deployed in various other embodiments, potentially in devices, which are not intended for capturing video, audio or images, but providing several features described herein.

Peripheral interface 150 provides any required physical/electrical and protocol interfaces needed for connecting different peripheral devices and/or other systems operating with different protocols. Merely for illustration, peripheral interface 150 is shown as a single block interfacing with multiple interface blocks. However, peripheral interface 150 may contain multiple units, each adapted for the specific interface block, as will be apparent to one skilled in the relevant arts.

Input and Output (I/O) interface 160 provides a user with the facility to provide inputs to the multi-media device and receive outputs. Input interface (e.g., interface with a keyboard or roller ball or similar arrangements, not shown) provides a user with the facility to provide inputs to the multi-media device, for example, to select features such as whether encoding is to be performed. Output interface provides output signals (e.g. to a display unit, not shown). The input interface and output interface together form the basis of a suitable user interface for a user.

Serial and Parallel interfaces 170 and other interfaces 180 (containing various peripheral interfaces known in the relevant arts, for example RS 232, USB, Firewire, Infra Red, etc.) enable the multi-media device to connect to various peripherals and devices using the respective protocols.

VI Bus and I²S Bus 190 represent example peripheral interfaces to which a multi-media source (e.g., a camera and a mic respectively) may be connected. These peripheral interfaces receive various multi-media signals (or corresponding digital values), which are encoded according to various aspects of the present invention as described in sections below. However, it should be appreciated that the multi-media signals (sought to be encoded according to various aspects of the present invention) can be received from other interfaces as well.

GPU memory 140 (which may be implemented using one or more of SRAM, SDRAM, DDR RAM etc) from which data may be retrieved for processing by GPU 130. GPU memory 140 may be integrated with GPU 130 into a single integrated circuit or located external to it. As an alternative, GPU memory 140 may contain multiple units, with some units integrated into GPU 130 and some provided external to the GPU. In addition to supporting encoding as described in sections below, GPU memory 140 may be used to store data to support various graphics operations, and to store a present frame based on which display signals are generated to a display unit.

Graphics Processor Unit (GPU) 130 generates display signals to a display unit (not shown), in addition to encoding of multi-media signals in accordance with an aspect of the present invention, as described in sections below. GPU 130 may have many other capabilities, for example rendering 2D and 3D graphics, etc., not described here in further detail. Typically, GPU 130 receives image data, as well as specific (2D/3D) operations to be performed, from CPU 110, processes the image data to perform the operation, and generates display signals to a display unit from the image data thus processed/generated.

Various aspects of the present invention enable multi-media signals to be encoded with reduced resource requirements. The features of the invention will be clearer in comparison to a prior approach to encoding. Accordingly the prior approach is described below first.

### 3. Prior Encoding Approach

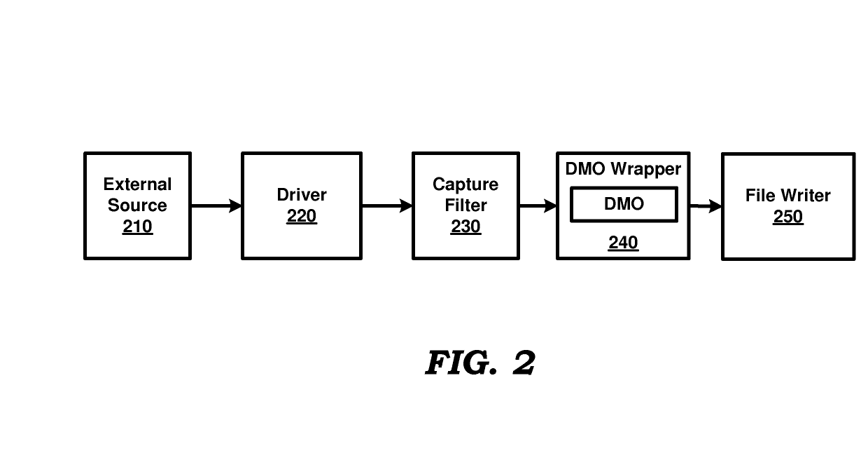

FIG. 2 is a block diagram illustrating the processing of multi-media signals in a prior embodiment. The embodiment is implemented in Microsoft's Windows Mobile 2.0 environment for ‘Pictures and Videos Application’. Merely for comparison and ease of understanding, some of the blocks are described in relation to FIG. 1.

Driver 220 operates due to execution of corresponding instructions in CPU (e.g., 110) and is designed to interface with an external source 210 to receive the raw multi-media data (e.g., PCM data in case of audio and RGB data in case of video). Driver 220 refers to a block which interfaces with the external device with which data/signals are to be exchanged, and is implemented taking into consideration the interfacing requirements of the external device as well as the other blocks of the device in which driver 220 is implemented.

Capture filter 230 receives multi-media data from driver 220, associates time stamps with the received data, and then send the combined data downstream to DMO 240. Capture filter may also include various data structures related to the multi-media signal prior to sending that information as well to DMO 240. The raw data as well as the other information thus sent, is stored in a system memory (e.g., 120).

Direct media object (DMO) 240 also operates due to execution of corresponding instructions in the CPU and is designed to encode the data stored in system memory 120, and store the encoded data back in the system memory. DMO may contain various methods (procedures), which are called by external applications. Some of the procedures may be called in relation to encoding. The encoding may potentially be performed by external components, e.g., by hardware implemented encoders or within a graphics processing unit (e.g., 130).

File writer 250 receives multiple streams of multi-media data (e.g., video and audio, as separate streams, though only a single stream is shown in FIG. 2 for conciseness), associates the respective portions based on the time stamps, and stores the streams of data in the system memory.

One problem with such an approach is that the data transfers may cause bottlenecks in components such as buses which are in the path of the system and GPU memories. For example, assuming the approach of FIG. 2 is implemented in the embodiment of FIG. 1, pre-encoding data may be first stored in system memory 120 upon reception, transferred to CPU 130 for encoding, and transferred back to system memory 120 after encoding. Due to such multiple transfers, bottlenecks may be encountered on system bus 115. The bottlenecks are of particular concern when large volumes of data are being transferred and device 100 corresponds to devices such as cameras and mobile phones (often implemented with limited resources).

An encoding approach implemented according to several aspects of the present invention overcomes some of such problems, as described below with examples.

### 4. Encoding Multi-Media Signals

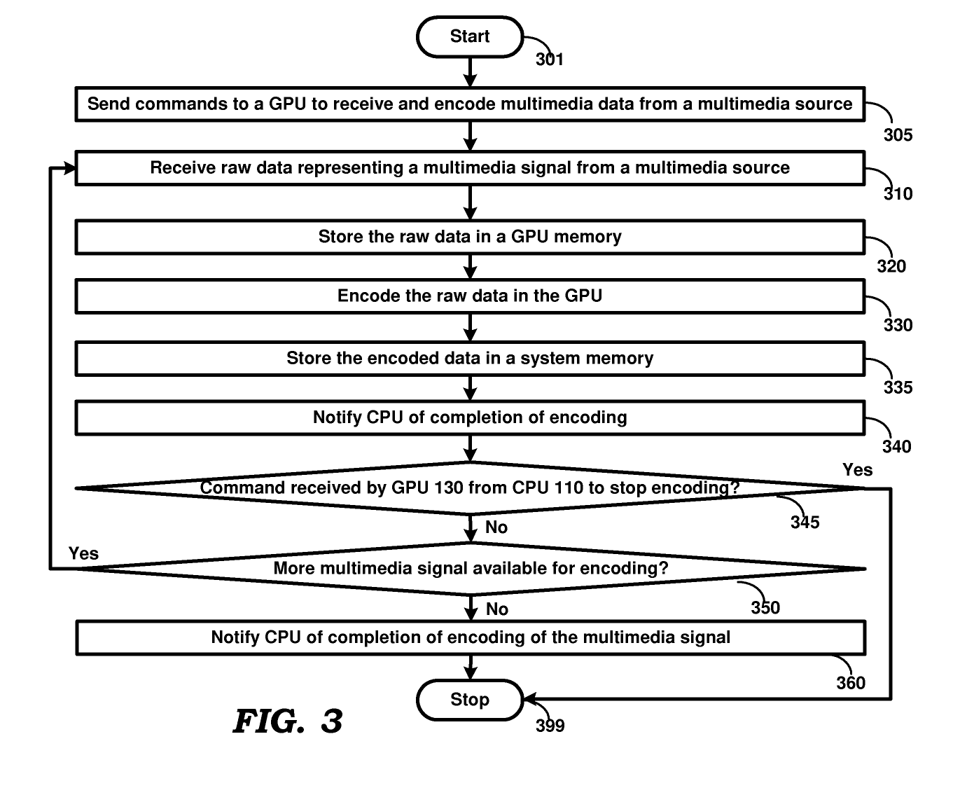

FIG. 3 is a flowchart illustrating the manner in which multi-media signals are encoded in an embodiment of the present invention. The flowchart is described with respect to FIG. 1, merely for illustration. However, various features can be implemented in other environments and other components. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 301, in which control passes immediately to step 305.

In step 305, CPU 110 sends one or more commands to GPU 130 to encode a multi-media signal from a multi-media source. The command may be sent on bus 115 using a suitable approach (e.g., packet based with content according to a pre-specified protocol or by asserting a specific signal line). The command can be sent in one of several known ways.

In step 310, GPU 130 receives raw multi-media data from a multi-media device. The raw multi-media data may contain raw audio data from an audio source (e.g. a mic) and raw video data from a video source (e.g. a camera). The data from the audio source and the video source are referred to as “raw” to indicate that the data has not been processed and is in the same format as provided by the source. In one embodiment, the data from a mic may be in PCM (pulse code modulation) format and the data from a camera may be in the RGB format, though data may be received from sources in a number of other formats as is known in the arts.

In step 320, GPU 130 stores the received raw data in GPU memory 140 using paths 139 and 141. By storing the raw data directly in GPU memory 140, instead of CPU 110 storing it in system memory 120 first and then transferring it to GPU memory 140, the bottlenecks in components such as buses in the path of the system and GPU memories, described above, may be mitigated. The raw data can correspond to different streams (potentially of different multi-media types), though the description below is provided with respect to a single stream (say of video or audio multi-media type).

In step 330, GPU 130 encodes the raw data (after retrieving the data from GPU memory 140). The output of such encoding may be in a compressed format, for example one of the well known formats noted before. GPU 130 may use any internally provided hardware based encoders or use software based instructions to perform encoding. The data may be encoded into a preset format or into a user selected format. The user may select the format with the input and out put interfaces 160 or any other ways as is known in the relevant arts. Though the description is provided assuming that the raw data is stored in GPU memory 140 and then encoded, it should be appreciated that by appropriate modifications (e.g., providing more hardware such as registers), the data can be encoded without storing the raw data in GPU memory 140.

In step 335, GPU 130 stores the encoded data into system memory 120. In step 340, GPU 130 notifies CPU 110 that encoding has been completed for at least a portion of the received raw multi-media data. CPU 110 may use this notification to provide the encoded data to downstream programs, for example, a program storing the encoded data in a storage device or processing the data further (e.g. in applications for editing multi-media content) or transmitting the data (e.g. from a mobile phone).

In step 345, GPU 130 checks whether a command has been received from CPU 110 to stop encoding of multi-media data. The CPU may generate such a command, for example, when a user wishes to stop processing the multi-media signal. If a command to stop encoding has been received, control passes to step 399, in which the flowchart ends. If the command has not been received, control passes to step 350.

In step 350, GPU 130 determines whether more multi-media data is available for encoding. There may not be any more multi-media data to be encoded because the sources may not be sending any more data or the sources may not be connected to the multi-media device any more or for other reasons. If there is no multi-media data available for encoding, control passes to step 360. If there is more multi-media data to be encoded, control passes to step 310 to receive and encode the next (immediate) portion of multi-media data.

In step 360, GPU 130 notifies CPU 110 that the encoding has been completed. Communication techniques such as interrupts or assertion of the appropriate signal paths on bus 115, may be used for such notifications. The flowchart ends in step 399.

It should be appreciated that the approaches described above may be implemented in various operating environments. The description is continued with respect to the implementation in an example operating environment.

### 5. Example Implementation

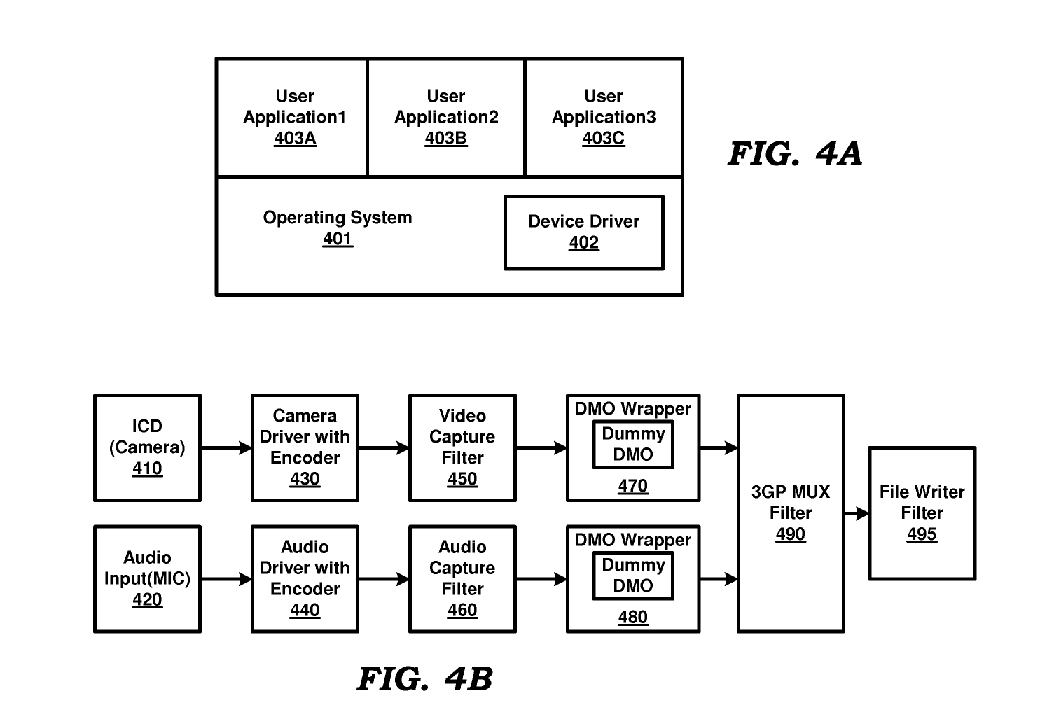

FIG. 4A is a block diagram illustrating an example operating environment and FIG. 4B is a block diagram illustrating the details of an implementation in the operating environment. The operating environment of FIG. 4A is shown containing operating system 401 and user applications 403A through 403C.

Operating system 401 refers to an executing entity which facilitates access of various resources to user applications 403A through 403C. In general, when device 100 is initialized, control is transferred to operating system 401. In an embodiment, operating system 401 corresponds to Windows Mobile 5.0 operating system provided by Microsoft Corporation.

Driver 402 (provided as a part of operating system 401) provides similar functionality as that described above with respect to driver 220. However, driver 402 is designed to issue to GPU 130 the command noted in step 305 above, to cause the encoding to be performed. Driver 402 may optionally perform any needed initializations/terminations (e.g., power up/down the source device of the multimedia signal, configure the source device for attributes such as resolution, frame rate, bit rate, sampling frequency, destination memory) in multi-media sources, GPU 130 and any other needed components (e.g., registers in CPU 110) before or as a part of issuing the command of step 305.

User applications 403A through 403C may correspond to various applications which may utilize (e.g., to record, play, view, etc., depending on the multi-media signal type) the multi-media signals encoded according to various aspects of the present invention. In an embodiment, each user application may be designed to provide integration of third party encoders by appropriate configuration. For example, in the Windows Mobile 5.0 operating system, registry entries may need to be configured to specify a program/procedure which will perform the required encoding.

In a prior embodiment, such encoding may be performed as described above with respect to FIG. 2 by execution of appropriate software instructions provided as a part of the configured program/procedure. As the encoding is performed automatically by GPU and stored in system memory 120, the need for encoding within user applications may be obviated. However, a user application may need to still support such program/procedure for compatibility with the operating environment. The manner in which such compatibility is attained is described below with an example.

FIG. 4B is a block diagram illustrating an example approach to encoding of multi-media signals in one embodiment of the present invention. The block diagram is described with respect to FIGS. 1-3 and 4A merely for illustration. However, various features can be implemented in other environments and other components. Furthermore, the operations are described in a specific sequence merely for illustration.

FIG. 4B shows two multi-media signals (or corresponding raw digital data), namely a video signal from a camera in video input 410 and an audio signal from a mic in audio input 420 which are to be encoded. For the purpose of conciseness and clarity, the description is continued with the respective blocks for encoding of video signals. The encoding of audio signals proceeds in a similar manner.

The embodiment is implemented in Microsoft's Windows Mobile 2.0 environment for ‘Pictures and Videos (P&V) Application’. Video capture filter 450, DMO wrapper 470, 3GP mux filter 490 and file writer 495 are contained in the P&V application (an example of a user application, noted above).

Camera driver with encoder 430 operates due to execution of corresponding instructions in CPU 110 as a part of device driver 402, and is designed to interface with video input 410 and to provide the command of step 305 noted above. Video capture filter 450 includes appropriate values (including time stamps) in various data structures related to the video signal and makes available the information for further processing.

DMO wrapper 470 represents a procedure/method that is called by other software code, when such other software code requires encoded data. As the video data has already been encoded in the video driver, there is no requirement of video encoding within the DMO. However, the P&V application requires that a DMO be present in DMO wrapper 470. Therefore, a dummy DMO, which accepts the data provided by video capture filter 450 and provides the data without any alteration or processing to 3GP mux filter 450, is provided. As this DMO does not alter or process the data, it is referred to as a dummy DMO.

3GP mux filter 490 receives multiple streams of multi-media data (e.g., video and audio as shown) as separate streams, associates the respective portions into a single stream of multi-media data, and sends the stream of data to file writer 460 for storing in a file.

Alternative embodiments in other environments, using other components, and different sequence of steps can also be implemented without departing from the scope and spirit of several aspects of the present invention, as will be apparent to one skilled in the relevant arts by reading the disclosure provided herein.

### 6. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A device processing a multi-media signal provided by an external source, said device comprising:
an interface connecting to said external source;
a random access memory (RAM) storing a plurality of instructions;
a central processing unit (CPU) executing said plurality of instructions; and
a graphics processing unit (GPU) receiving a plurality of digital values representing said multi-media signal from said external source, encoding said plurality of digital values to generate a plurality of encoded values and storing said plurality of encoded values in said RAM,
wherein said plurality of digital values are received by said GPU without being stored in said RAM.

2. The device of claim 1, further comprising a GPU memory, wherein said GPU stores said plurality of digital values in said GPU memory prior to performing said encoding.

3. The device of claim 1, wherein said plurality of digital values comprise raw data received from said interface.

4. The device of claim 1, wherein said GPU notifies said CPU upon completion of storing encoded data corresponding to each of a successive portions of said multi-media signal.

5. A method of encoding multi-media signals provided by an external source, said method comprising:
sending a command to a graphics processing unit (GPU) to encode said multi-media signals;
receiving in said GPU a plurality of digital values representing said multi-media signal from said external source;
encoding said plurality of digital values in said GPU to generate a plurality of encoded values; and
storing said plurality of encoded values in a system memory by said GPU.

6. The method of claim 5, wherein said GPU stores said plurality of digital values in a GPU memory.

7. The method of claim 5, wherein said plurality of digital values comprise raw data received from said interface.

8. The method of claim 5, wherein said GPU notifies said CPU upon completion of storing encoded data corresponding to each of a successive portions of said multi-media signal.

9. The method of claim 5, wherein the method is incorporated into a device driver for said external source.

10. The method of claim 5, wherein said GPU checks whether a command has been received from said CPU to stop encoding.

11. A computer readable medium containing a plurality of instructions which when executed causes one or more processors to process a multi-media signal provided by an external source, said computer readable medium comprising:
code for sending a command to a graphics processing unit (GPU) to encode said multi-media signals;
code for receiving in said GPU a plurality of digital values representing said multi-media signal from said external source;
code for encoding said plurality of digital values in said GPU to generate a plurality of encoded values; and
code for storing said plurality of encoded values in a system memory by said GPU.

12. The computer readable medium of claim 11, wherein said code for sending comprises a driver software, which sends said command.

13. The computer readable medium of claim 11, further comprising a user application code representing a procedure designed for invocation by other codes when said plurality of digital values are to be encoded, wherein said procedure returns without performing said encoding.

14. The computer readable medium of claim 11 further comprising code for said GPU notifying said CPU upon completion of storing encoded data corresponding to each of a successive portions of said multi-media signal.

15. The computer readable medium of claim 11 further comprising code for checking by said GPU whether a command has been received from said CPU to stop encoding.
